(19) United States
(12) Patent Application Publication
(10) Pub. No.: US 2007/0262011 A1
(43) Pub. Date: Nov. 15, 2007

(54) Recirculating water purification system & method

(76) Inventors: Mehdi Hatamian, Coto De Caza, CA (US); Mehrtosh A. Ghalebi, Rancho Santa Margarita, CA (US)

Correspondence Address: STETINA BRUNDA GARRED & BRUCKER, 75 ENTERPRISE, SUITE 250, ALISO VIEJO, CA, 92656, US

(21) Appl. No.: 11/799,566

(22) Filed: May 2, 2007

Related U.S. Application Data
(60) Provisional application No. 60/797,156, filed on May 2, 2006.

(51) Int. Cl. C02F 1/02

(52) U.S. Cl. 210/175; 210/149; 210/742

(57) ABSTRACT

Recirculating water purification system and method for use with conventional water coolers and the like having a water temperature control device, such as a refrigeration unit or heating element. The invention utilizes a peltier module operative to define a recirculating flow of water within a water reservoir used with the water cooler. Conventional water purification means, such as a water filter, ultraviolet (UV) light, and the like are operatively interconnected with the peltier module so that the water flowing therethrough is continuously purified. Energy to operate the peltier module, and optionally the water purification devices, is provided by-product heat or energy emanating from the water temperature control device. The systems and methods can be used in virtually all types of closed systems.

### CROSS-REFERENCE TO RELATED APPLICATIONS

The present application claims priority to Provisional Patent Application Ser. No. 60/797,156, entitled RECIRCULATING WATER PURIFICATION SYSTEM & METHOD, filed May 2, 2006.

### STATEMENT RE: FEDERALLY SPONSORED RESEARCH/DEVELOPMENT

Not Applicable

### BACKGROUND

The present invention generally relates to methods and systems for recirculating and maintaining the purity of water in a closed system, and more specifically to methods and systems for recirculating and maintaining the purity of water in a closed system, such as a water cooler, that are operative to function from byproduct heat or energy given off by a refrigeration unit, water heater or other type of water temperature control device used in conjunction with such system.

Water coolers and other systems for selectively dispersing potable water are well-known in the art. Generally, such systems comprise a housing for receiving or interconnecting with a source of potable water, and further typically include devices such as refrigeration units and/or heating elements that are operative to refrigerate or heat the water to a desired temperature when the same is ultimately dispensed. Along these lines, water coolers and the like are in wide spread use and offer the advantage of providing consumers with more highly purified, better tasting drinking water than is typically provided from municipal water systems (i.e., “tap” water).

Despite such advantages, however, water coolers and the like suffer from the disadvantage of requiring a reservoir of water to essentially remain stagnant until depleted. By virtue of the water remaining stagnant, coupled with the fact that the reservoir, typically a multi-gallon water bottle, is manually replaced or otherwise frequently exposed to contaminants, the purity of the water can often be compromised.

Accordingly, there is a substantial need in the art for a system and method that can enable water stored within water reservoir of a water cooler or other like device to be continuously purified to thus maintain optimal water quality. There is additionally a need in the art for such a system that can provide water purification means that can be readily incorporated as part of a conventional water cooler and the like and further, can be operatively powered from byproduct energy or heat as dissipated from either a refrigeration unit and/or heating element already operatively integrated as part of such water cooler. There is additionally a need in the art for such a system and method that is of simple construction, cost efficient and substantially effective in providing continuous purification means.

### BRIEF SUMMARY

The present invention specifically addresses and alleviates the above-identified deficiencies in the art. In this regard, the present invention is directed to a recirculating water purification system that is operative to continuously repurify water present within a water reservoir as incorporated as part of a water cooler or other like system having a water temperature control device, such as a refrigeration unit and/or heating element. Preferably, a water reservoir will be provided with a peltier module and water-cooled heat sink, such as that disclosed in Applicant's co-pending provisional application entitled PELTIER SYSTEM WITH WATER PURIFICATION MEANS, filed on May 2, 2006 and assigned Ser. No. 60/797,291, the teachings of which are expressly incorporated herein by reference. In this regard, such peltier module will be operative to define a recirculating flow of water within the reservoir. Operatively coupled to the peltier module will be at least one water purification device, which may consist of a conventional water filter, ultraviolet (UV) light exposure system, or any convention type of water purification device known in the art as well as any combination thereof. The peltier module will preferably be operatively coupled to either the refrigeration unit and/or heating element provided as part of the cooling system to thus provide the energy necessary to generate a flow of water through such module. In this regard, the construction and operation of the peltier module may be constructed according to well-known and recognized principals as readily understood by one skilled in the art. Optionally, the water purification means may also be powered by such by-product heat or energy. Alternatively, such water purification means, and in particular the usage of UV lamps and the like, may be powered by an external electrical power source.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a diagram depicting the recirculating purification system of the present invention as incorporated as part of a conventional water cooler coupled to a water reservoir.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

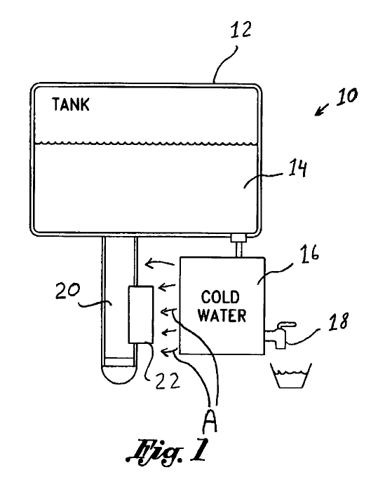

Referring now to FIG. 1, there is shown a conventional water cooler 10 incorporating therein a recirculating water purification system as contemplated by the present invention. As illustrated, the water cooler 10 comprises the combination of a reservoir 12 of water 14, which preferably comprises pre-purified water, a water temperature adjustment device 16, and means for dispensing the water 18, preferably at a temperature regulated by the water temperature device 16.

Such water cooler systems are well-known in the art and may take a variety of forms that will be readily understood and appreciated. FIG. 1 is meant to simply exemplify the basic components of such system. Along these lines, it should be understood that the water temperature control device 16 can take the form of any device that is operative to either reduce or increase the temperature of the water being dispensed from the system, and will typically comprise either a refrigeration unit for providing cold water, as expressly stated, or a heating element operative to provide hot water.

The system of the present invention is operative to provide a recirculating flow of water within the reservoir 12 that is continuously purified to thus enable the water 14 stored therein to retain and maintain a high degree of purity, even in the event that the reservoir becomes contaminated. As is well-known in the art, water reservoirs, by simple handling, exposure to air and the like are known to become easily contaminated, and thus thwart the ability of such systems to preserve water purity.

To achieve that end, the system of the present invention utilizes a peltier module 20 that is operatively interconnected with the water reservoir 12 to thus define a continuous recirculating flow of water within the system. The structure and operation of peltier systems are well-known in the art. Exemplary of such peltier modules that are well-suited in the practice of the present invention include those disclosed in Applicant's co-pending provisional patent application entitled PELTIER SYSTEM WITH WATER PURIFICATION MEANS, filed on May 2, 2006 and assigned Ser. No. 60/797,291, the teachings of which are expressly incorporated herein by reference. Other types of peltier systems are also capable of being readily integrated in the practice of the present invention.

The peltier module 20 is preferably interconnected to the water temperature control device 16 such that by-product heat, represented by “A”, or energy emanating from the water temperature control device 16 will be operative to provide the energy necessary for the peltier module to generate a recirculating flow of water therethrough. Advantageously, the water temperature control device 16 will, by virtue of its operation, generate excessive heat or energy that could be readily harnessed by the peltier module 20 and thus generate the temperature gradient operative to generate fluid flow therethrough.

Operatively coupled to the peltier module is at least one water purification means 22, which can take any type of water purification device known in the art, such as a water filter or UV lamp, and the like. The water purification means 22 is operatively interconnected to the peltier module 20 such that the fluid passing therethrough is purified as the water is recirculated within the water reservoir 12. As such, by virtue of the continuous recirculating flow of water from the reservoir 12 to the peltier module 20 and back, water 14 is continuously purified and maintained in its ideal pure form. Accordingly, any contaminants that are present in the water will thus ultimately be removed therefrom.

In an optional embodiment, to the extent the water purification means 22 will necessarily be powered, it is contemplated that to the extent this power can further be drawn from the water temperature control device 16, as derived by the peltier module 20, the same can further be provided to thus power the water purification means 22. According to such embodiment, the system of the present invention is thus operative to conserve energy and make efficient use of energy that would otherwise be wasted by the water temperature control device 16. It should be understood, however, that to the extent necessary, power to the water purification means 22 can be provided by an external power source if necessary or desired.

Additional modifications and improvements of the present invention may also be apparent to those of ordinary skill in the art. Along these lines, it will be understood that the systems and methods disclosed herein can be used with virtually all types of closed systems where an enclosed water reservoir is utilized. Thus, the particular combination of parts and steps described and illustrated herein is intended to represent only certain embodiments of the present invention, and is not intended to serve as limitations of alternative devices and methods within the spirit and scope of the invention.

What is claimed is:

1. A recirculating water purification system comprising:
a. a water cooler operatively interconnected to a reservoir of water and having a water temperature control device for modifying the temperature of the water as dispensed therefrom;
b. a peltier module operatively interconnected with said reservoir and said water temperature control device, said peltier module being operative to define a recirculating flow of water within said water reservoir from energy derived from said water temperature control device; and
c. water purification means operatively coupled to said peltier module, said water purification means being operative to purify said flow of water flowing through said peltier module.

2. The system of claim 1 wherein said peltier module is operative to create a flow of water passing therethrough via heat derived from said water temperature adjustment device.

3. The system of claim 2 wherein said water temperature adjustment device comprises a device selected from the group consisting of a refrigeration unit and a heating element.

4. The system of claim 1 wherein said water purification means is selected from the group consisting of a water filter and UV light.

5. A method for providing continuous water purification within a closed reservoir of water comprising the steps:
a. providing a closed reservoir of water, a peltier module, water purification means, a water temperature control device;
b. operatively interconnecting said peltier module with said reservoir of water such that a recirculating flow of water can pass from said reservoir through said peltier module and back to said reservoir;
c. operatively interconnecting said peltier module with said water temperature control device such that heat or energy emanating from said water temperature control device is operative to produce a flow of water from said reservoir through said peltier module; and
d. using said water purification means to purify said water flowing through said peltier module in step (c).
